(19) United States
(12) Patent Application Publication
(10) Pub. No.: US 2005/0188158 A1
(43) Pub. Date: Aug. 25, 2005

(54) Cache memory with improved replacement policy

(76) Inventor: Richard P. Schubert, Medfield, MA (US)

Correspondence Address: Edmund J. Walsh;Wolf, Greenfield & Sacks, P.C., 600 Atlantic Avenue, Boston, MA, 02210, US

(21) Appl. No.: 10/786,250

(22) Filed: Feb. 25, 2004

(51) Int. Cl. G06F 12/00

(52) U.S. Cl. 711/133; 711/128

(57) ABSTRACT

A processor system having a cache memory. The replacement policy for the cache is augmented with a consideration of priority so that higher priority items are not displaced by lower priority items. The priority based replacement policy can be used to allow processes that are of lower priority to share the same cache with processes that are of higher priority. A processor including digital signal processing and general purpose logic function is shown to employ the priority based replacement policy to allow processes executing generalized logic functions to use the cache when not needed for digital signal processing operations that are time critical. A processor having digital signal processing capability is shown to employ the priority system to reserve a block of memory configured for a cache. The block of memory is reserved by setting the priority of those cache locations to a priority higher than any other executing process.

### BACKGROUND OF INVENTION

1. Field of Invention

This invention relates generally to computerized data processors and more specifically to the memory subsystems of such processors.

2. Discussion of Related Art

Computer data processors are widely used in modern electronic systems. Some are designed for specialized functions. One example is a digital signal processor (DSP). A digital signal processor is configured to quickly perform complex mathematical operations used in processing of digitized signals.

FIG. 1 shows a high level block diagram of a computerized data processor. FIG. 1 could represent a general purpose computerized data processor or it could represent a special purpose data processor, such as a digital signal processor. FIG. 1 illustrates a processor chip 100. Within processor chip 100 is a processor core 110. In operation, processor core 110 reads instructions from memory and then performs functions dictated by the instruction. In many cases, these instructions operate on data that is also stored. When an operation performed by processor core 110 manipulates data, the data is read from memory and results are generally stored in memory after the instruction is executed.

FIG. 1 shows that processor chip 100 includes a level 1 instruction memory unit 112 and a level 1 data memory unit 116. Both the instruction memory unit 112 and data memory unit 116 are controlled by a memory management unit 114. Instruction memory unit 112 and data memory unit 116 each contain memory that stores information accessed by processor core 110 as instructions or data, respectively.

Level 1 memory is the fastest memory in a computer system. The area required on an integrated circuit chip to implement level 1 memory often makes it impossible to build a processor chip with enough level 1 memory to store all the instructions and all the data needed to run a program. Therefore, a computer system includes level 2 or level 3 memory, level 3 memory is generally very slow but stores a lot of information. Disk drives, tapes or other bulk storage devices are generally used to implement level 3 memory. Level 2 memory is typically semiconductor memory that is slower then level 1 memory. Level 2 memory might be located off-chip. In some cases, level 2 memory is implemented on processor chip 100, but is slower than level 1 memory. For example, level 1 memory might be SRAM and level 2 memory might be DRAM.

The computer system of FIG. 1 shows off-chip memory 150 that could be level 2 or level 3 memory. Integrated circuit 100 includes a memory interface 122 that can read or write instructions or data in memory 150. Memory 150 is not implemented on semiconductor chip 100.

In designing a computerized data processing system where speed of operation is a concern, an effort is made to use level one memory as much as possible. Semiconductor chip 100 is configured so that memory operations involving instructions or data pass first through level one instruction memory unit 112 or level one data memory unit 116, respectively. If the needed instruction or data is not located within those units, those units can access memory interface 132 through internal bus interface 130. In this way, processor core 110 receives the required instruction or data regardless of where it is stored.

To make maximum use of L1 memory, a memory architecture called a cache is often used. A cache stores a small amount of information in comparison to what can be stored in level two and level three memories. Initially the cache stores a copy of information contained in a level two or level three memory location. As processor core 100 needs to read or write to that memory location, it uses the information in the cache instead of accessing the level 2 or level 3 memory. “Policies” that determine what information is stored in the cache are intended to increase the likelihood that information required by processor core 110 is stored within the cache.

Control circuitry implements the cache “policies” by controlling when information read from the level 2 or level 3 memory is stored in the cache and when information in the cache is written into the level 2 or level 3 memory. Policies also dictate when the control circuit can overwrite or delete information in the cache. Before information in a cache is overwritten or deleted, if it has been changed from what is in the level 2 or level 3 memory, it must be written back to the level 2 or level 3 memory. Policies also control timing of writes of cached information back to level 2 or level 3 memory.

In the following description, a cache is explained in terms of data read from memory. It should be appreciated, though, that a cache can store information to be written into level 2 or level 3 memory.

Control circuitry for the cache must take into account that not all data accessed by processor core 110 should be stored in a cache. For example, FIG. 1 illustrates a computerized processor with a memory mapped architecture. Data may be acquired from or sent to locations other than a memory storage device. Processor core 110 may perform an operation based on data from timer 136 or may send data to timer 136 to control its operation. Likewise, data may be sent or received from peripherals, such as a printer, attached to semiconductor chip 100. To interface to peripherals, a serial interface 134 may be used.

Timer 136 and serial interface 134 are assigned memory addresses. When processor core 110 performs an operation that requires data from these locations or generates data to be sent to these locations, internal bus interface 130 routes the information to the appropriate location based on the address that has been assigned to these devices. It should be appreciated, though, that reading from a cache a copy of information read from a timer at a previous instant in time is not the same as reading from the timer at a later instant of time because the value in the timer may change. Accordingly, the control circuitry for a cache must preclude reads or writes to the memory addresses assigned to the timer from using or storing data in the cache.

More complicated examples of the need to control whether a memory operation can be performed using information in a cache exist in multi-process systems. Software programs executing in processor chip 100 may create processes. Each process may exist for a period of time and terminate when the operation performed by the process is completed. A first process may store information in a particular memory location. When the first process terminates, a second process may use that same memory location. But, if the processor provides the second process with data stored in the cache for the first process, incorrect operation may result.

As a further example, the contents of some memory locations may be altered by “Direct Memory Access” (DMA) operations. DMA operations do not initiate in processor core 110. DMA operations would be controlled by DMA controller 138 and would not pass through memory controllers 112 and 116. Thus, the information in the cache would not be updated if a DMA operation involving an address stored in the cache occurred.

The portion of the cache control circuit that determines which locations in the level two or level 3 memory can be cached is sometimes called a “Cacheability Protection Look aside Buffer” (CPLB). In prior processors with CPLB circuits, the CPLB is implemented as a memory table storing information about blocks of memory—such as which process uses the information in each block and whether memory locations within a block are subject to updating by circuitry other than the processor core 110.

FIG. 2 shows a block diagram of a cache 200, including a CPLB 250. Other control circuitry is not specifically shown. However, it is well known in the art that semiconductor circuits, including those relating to memories, contain timing and control circuits so that the circuitry achieves the desired operation.

In a preferred embodiment, cache 200 represents the cache circuits within L1 instruction memory unit 112 and L1 data memory unit 116. The physical architecture of the cache does not depend on the type of data stored in the cache. In operation, processor core 110 generates an address on address line 202. The specific number of bits in the address line is not important. The address is shown to have an X portion and a Y portion. Each portion of the address is made up of some number of the total bits in the address. The X portion and the Y portion of the address together define the address of the smallest “item” of memory that cache 200 stores.

An “item” of information in a cache may be an individual word or byte. However, most semiconductor memories are organized in rows. Time is required to set up the memory to access any row. Once the memory is set up to access the row, the incremental time to read another location in the row is relatively small. For this reason, when information is read from level two or level three memory to store in a cache, an entire row is often read from the memory and stored in the cache. Little additional time is required to store an entire row, but significant time savings results if a subsequent memory operation needs to access another location in the row. In this case, the “item” stored in the cache corresponds to an entire row in the level 2 or level 3 memory.

Additional address bits are applied to the cache 200 to select a particular piece of information from the item. For simplicity, FIG. 2 shows address lines to access an “item” but does not show additional circuitry or address lines that may be present to access a particular memory location within any item. Also, a cache that stores “items” with multiple words will some times have a fill buffer. The fill buffer holds words being read from level 2 or level 3 memory until an entire item is read and transferred from the fill buffer to the cache. Such circuitry is not expressly shown because the invention will work with or without a fill buffer. Where a fill buffer is used, the tag array location associated with an item to be stored in the data array might be updated before or during the processes of reading values into the fill buffer. Alternatively, the tag array could be updated after information is stored in the data array. The specific process of updating the array, as well as other processes and features not critical to the invention, are not fully described for simplicity, but one of skill in the art will understand that such processes or features might be used.

FIG. 2 shows that cache 200 contains a tag array 210 and a data array 220. Each location 222₁, . . . 222_{N} in data array 220 can store an “item”. Tag array 210 contains corresponding locations 212₁ . . . 212_{N}. The locations in tag array 210 indicate whether an item is stored in the corresponding location in data array 220 and, if so, which memory address the item is associated with. Each of the locations 212₁ . . . 212_{N} has multiple fields (not numbered). A first field stores an indication of whether valid data is stored in the corresponding location in data array 220. This field is sometimes called the “data valid” field. The second field in each of the locations 212₁ . . . 212_{N} identifies the address in level 2 or level 3 memory that is stored in the cache. This field is sometimes called the “tag” field. The tag array has fields to store other control bits. For example, a bit might indicate whether the information stored in the data array is a current copy of information in the corresponding level 2 or level 3 memory location or whether it has been modified. Another field might store bits indicating a “policy” applicable to that cache location.

To simplify the construction and increase the speed the operation of the cache 200, the locations within cache 200 in which the information for any level 2 or level 3 memory location may be stored are constrained. As shown, the Y portion of the address bits of each external memory address are applied to tag array 210 and data array 220. The Y portion of the address bits are used to select one of the locations within these arrays. If information from a level 2 or level 3 address having those Y portions is stored in the cache, it will be stored at the selected location. To indicate that information has been stored in the data array, the data valid field in the corresponding location in the tag array is set.

Because many external addresses have the same values for their Y bits but different values for the X bits, the information stored in the data array could correspond to multiple external addresses. To distinguish between the many locations that might correspond to the same Y bits, the tag field in the tag array stores the X bits of the address that is being represented by the information in the cache.

To determine whether cache 200 stores information for a specific address in external memory, the Y bits are used to access a particular location in tag array 210. If the data valid field in that location is set, the tag field in the location addressed by the Y address bits is applied to comparator 230. A second input to comparator 230 comes from the X bits on address line 202. If the X bits match, then the location within data array 220 addressed by the same Y bits can be used in place of making an access to external memory.

Where information already stored in cache 200 can be used in place of making an access to external memory, it is said that the access resulted in a cache “hit.” Conversely, where the cache does not store information corresponding to the external address being accessed, a “miss” is said to occur.

To increase the chance of a “hit,” cache 200 is constructed with multiple “ways.” A way is sometimes also called a bank. In the illustration of FIG. 2, two ways 210A and 210B are shown in tag array 210 and a corresponding two ways, 220A and 220B, are shown for data array 220. Each way is addressed by the Y bits of the external address as described above. However, because the tag array can store a different tag in each way for the same Y values, having two ways allows two locations with the same Y bits to be stored in the cache. Being able to store twice as many values nearly doubles the chances of a “hit” and therefore reduces the time required for memory access.

Increasing the number of ways to 4 or more would further increase the chance of a hit and creates a corresponding reduction in memory access time. However, the number of ways cannot be arbitrarily increased. First, doubling the number of ways doubles the space required on a processor chip 100 to implement the cache. A main reason for having a cache is because it is uneconomical to make large memories on a processor chip. Further, to achieve an increase in speed by having multiple ways, it is necessary that accessing the information in the ways must not take significant additional time.

Accordingly, comparator 230 contains additional circuitry for each way to simultaneously compare the value in the tag field with the X address bits of the applied address. The output of comparator 230 indicates whether there is a match between the X bits of the applied address and the X bits at the location in any of the ways of the tag array addressed by the Y bits.

The output of comparator 230 also indicates in which way the match was found. The output of comparator 230 is provided to multiplexer 240. Multiplexer selects the output of the appropriate way when there is a cache hit. If information corresponding to the applied address is not stored in any way, then there is a cache “miss.”

When a cache miss occurs, the level 2 or level 3 memory location containing the addressed information is read. Cache control circuitry causes this information to be stored in cache 200. If there is a location in at least one of the ways addressed by the same Y address bits as the applied address that does not already hold valid data, cache control circuitry causes the new information to be stored in an unused location. However, if all the locations with the same Y address bits in all of the ways hold valid information, the information in one of the ways must be replaced by the new information to be stored in the cache.

One of the “policies” implemented by the cache control circuitry is a “replacement policy.” The replacement policy dictates which way is selected for replacement. Commonly used replacement policies include the Least Recently Used (LRU), Least Recently Loaded (LRL) and Least Frequently Used (LFU). In other instances, the way to be replaced is selected psuedo randomly. Psuedo randomly means that the location is not selected based on the contents of the location. For example, psuedo random replacement could be achieved with a random number generator, though other mechanisms of selecting a location are possible.

### SUMMARY OF INVENTION

It is an object of the invention to provide a cache with an improved replacement policy.

The foregoing and other objects are achieved in a cache that has a priority indication associated with locations in the cache. The replacement policy selects a location for replacement based in part on the priorities.

In a preferred embodiment, priorities are associated with blocks of memory in the CPLB. When an item is stored in a cache, the priority indication associated with the block containing that item is copied into a priority field in the tag array.

In one aspect, the invention allows low priority and high priority processes to use the same cache. In a preferred embodiment, priority indications are assigned to blocks of memory based on the processes with which those blocks of memory are associated. Processes performing time critical functions are given higher priority than processes performing less time critical functions.

In another aspect, the priority indications are used to dynamically reserve portions of the on-chip memory for processes that require predictable timing for memory access. To reserve a portion of the on-chip memory, the highest priority is assigned to the cache locations that would otherwise occupy that portion of on-chip memory, guaranteeing that the memory locations in the data array corresponding to those locations will not be used by the cache. In a preferred embodiment, the cache is used in connection with a processor chip that contains digital signal processing circuitry and circuitry for performing general processor functions. The portion of the on-chip memory associated with the reserved cache locations can be used for direct access by processes performing time critical digital signal processing tasks.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a block diagram of a prior art processor chip;

FIG. 2 is a block diagram of a prior art memory cache for the processor chip of FIG. 1;

FIG. 3 is a block diagram of an improved memory cache for the processor chip of FIG. 1;

FIG. 4 is a flow chart of a method of storing information in the cache of FIG. 3; and

FIG. 5 is a block diagram showing dynamic reservation of cache memory.

### DETAILED DESCRIPTION

This invention is not limited in its application to the details of construction and the arrangement of components set forth in the following description or illustrated in the drawings. The invention is capable of other embodiments and of being practiced or of being carried out in various ways. Also, the phraseology and terminology used herein is for the purpose of description and should not be regarded as limiting. The use of “including,” “comprising,” or “having,” “containing”, “involving”, and variations thereof herein, is meant to encompass the items listed thereafter and equivalents thereof as well as additional items.

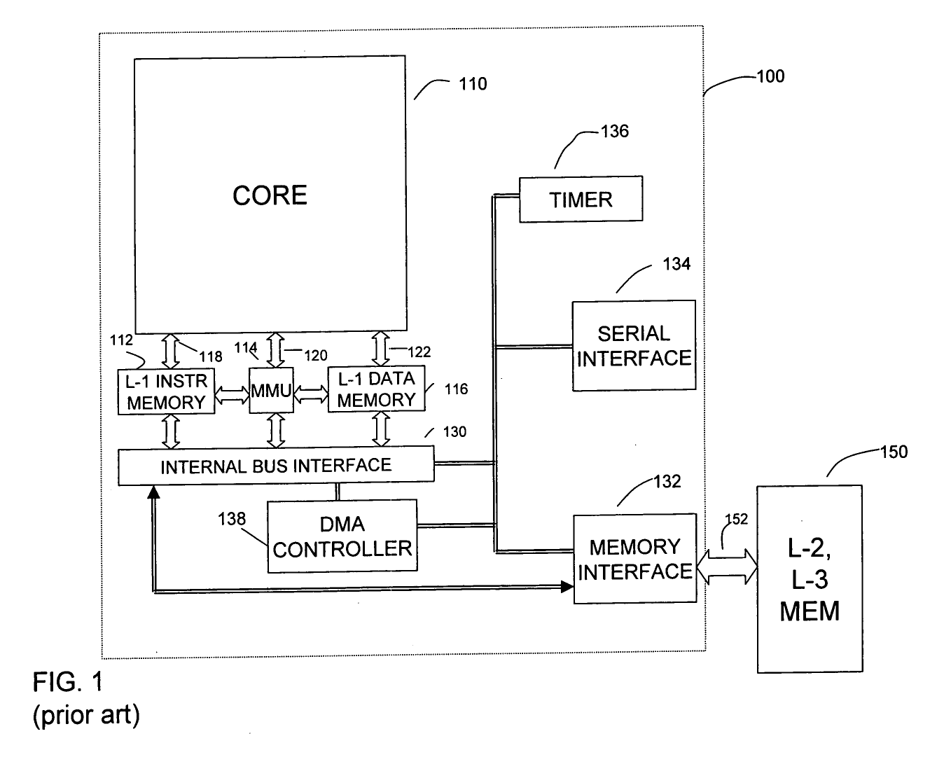

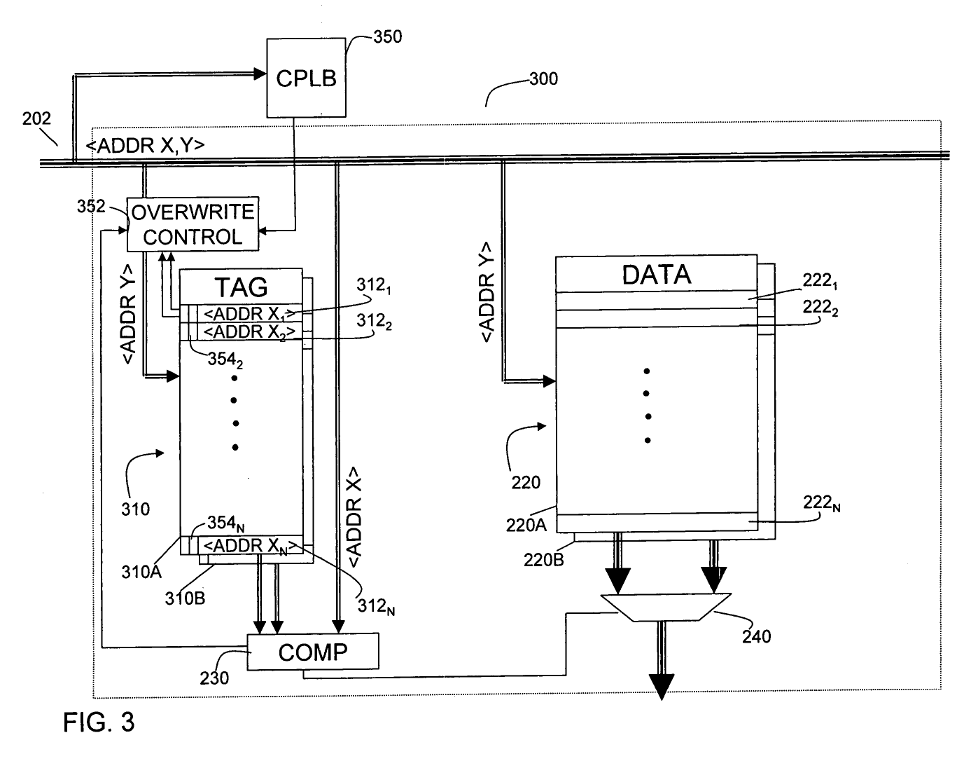

We have recognized that significant improvement can result in a processor chip from slight changes in the replacement policy of the on-chip cache memories. FIG. 3 shows the architecture of an improved memory cache 300, which can be used in a processor such as shown in FIG. 1. Cache 300 may be used as part of level 1 instruction memory unit 112 or level 1 data memory unit 116. Alternatively, cache 300 may represent a cache implemented in other memory, such as level 2 memory.

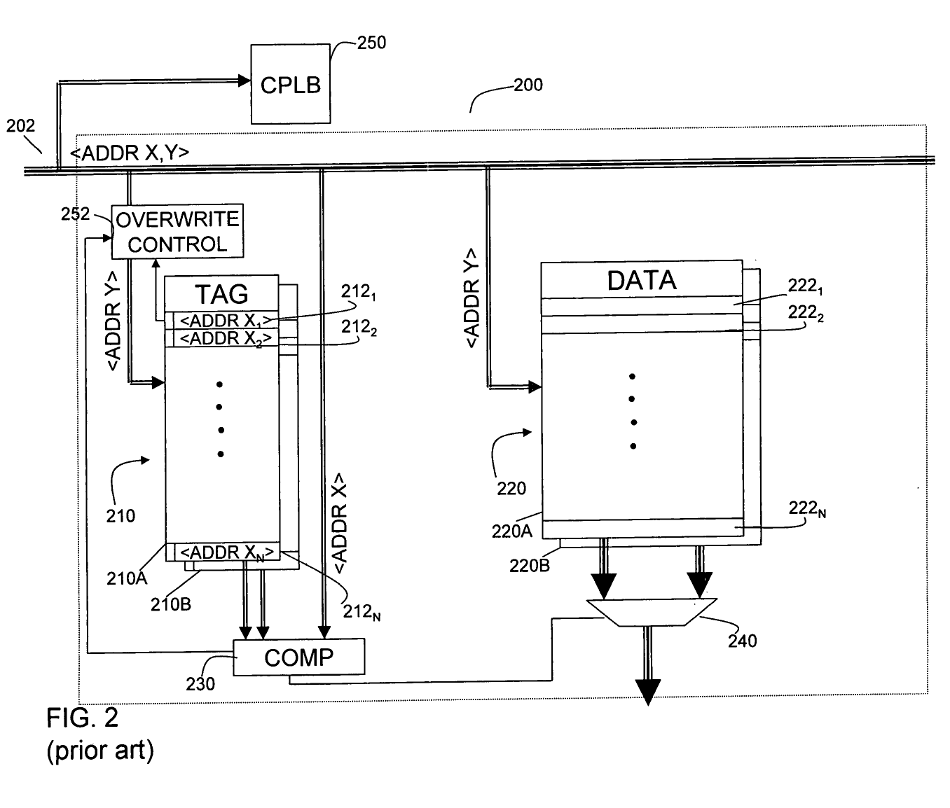

Cache 300 contains a data array 220, which can have the same structure as data array 220 shown in FIG. 2. As in the prior art, tag array 310 has locations that correspond to the locations in data array 220. Both the tag array and the data array are shown with multiple ways. In the illustration of FIG. 3, tag array 310 includes ways 310A and 310B. The ways in the tag array 310 correspond to ways 220A and 220B in data array 220. Also as in the prior art, each location 312₁, 312₂ . . . 312_{N} in each way of tag array 310 includes a tag field and a data valid field. Other status or control fields as in the prior art could be present, but are not shown. In addition, each location is augmented with a priority field 354₁, 354₂ . . . 354_{N}. In a preferred embodiment, the priority fields do not impact the manner in which data is read from cache 300. As described above, the Y portion of an address applied on bus 202 is used to index a location in tag array 310. The tag value stored in the indexed location for each way is provided to comparator 230. Comparator 230 compares the tag values with the X portion of the address applied on bus 202. If there is a match, the output of comparator 230 is provided to selector 230 to select the output of the appropriate way in data array 220.

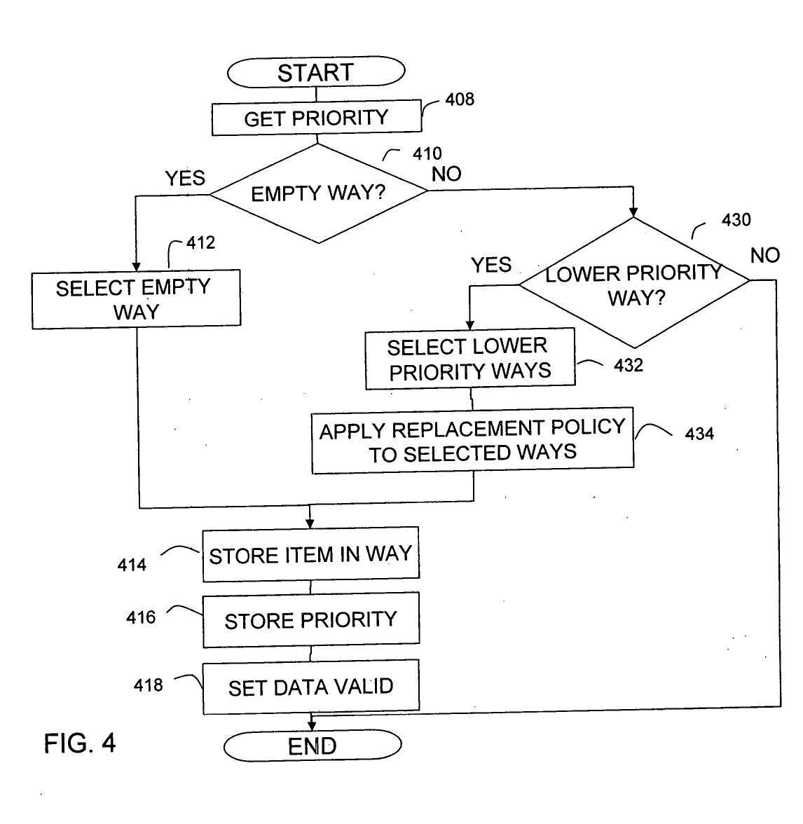

The priority fields are used in the event of a miss. As described above, when a cache miss occurs, information is fetched from level 2 or level 3 memory. In the prior art, the information fetched from memory was then stored in the cache, sometimes requiring the cache control circuit to select a location to store the new information that would result in information already in the cache being replaced. FIG. 4 shows a modification to the method used by the cache control circuitry for cache 300 that may be used for more efficient cache operation.

FIG. 4 shows a process for selecting a location in the cache to store an item newly fetched from level 2 or level 3 memory. At step 408, the priority of the new item to be stored is obtained. In the illustrated embodiment, CPLB 350 stores priorities associated with blocks of memory addresses. The priority of any specific address is determined by finding the block in CPLB 350 containing that address and reading the priority associated with that block. In a preferred embodiment, step 408 can be performed at the same time that CPLB 350 is consulted to determine whether the new information should be stored in the cache.

At step 410 a check is made to determine whether the location in any of the ways corresponding to the Y address bits of the item of information fetched from level 2 or level 3 memory is empty. If the location in one of the ways is empty, meaning that the data valid bit is not set, processing proceeds to step 412.

At step 412 one of the ways with an empty location is selected. This process can be as in the prior art.

Processing continues to step 414 where the item fetched from off-chip memory is stored in the selected way. Step 414 can also be as in the prior art. For example, this step may include buffering individual words in an item until the full item is ready to write in the cache.

At step 416, information is stored in the priority field of the selected location. In a preferred embodiment, the priority bit indicates the importance of maintaining the item of information available in cache memory. In the preferred embodiment, priorities are assigned to items in memory based upon the process which accessed that item of information. For example, processes performing digital signal processing functions that must be performed in real time are assigned higher priorities than processes performing generalized logic functions. For example, if cache 300 is used in a processor chip that drives a cell phone, a process that filters the incoming signal to be presented to a human user as a audio signal is given a higher priority than a process that periodically updates a status display.

At step 416 other control on status bits can also be stored. For example, the bits indicating the replacement policy might be stored. Also, as part of overwriting a location, the information in that location might be written back to level 2 or level 3 memory before it is destroyed by the overwrite. The process of determining when information must be written back to memory may be as in the prior art.

In the presently preferred embodiment, process priorities are assigned by a human programmer developing the software that runs on a processor chip using cache 300. In the presently preferred embodiment, the priorities associated with each process are stored in CPLB 350. As described above, each process is assigned certain blocks within memory and CPLB stores the correspondence between the processes and the allocated memory blocks. The CPLB can be readily augmented to include a priority assignment for each block of memory. In the presently contemplated embodiment, the priority field stores a single bit, allowing two levels of priority. However, any convenient number of priority bits can be used, allowing more than two priorities to be available.

Once the item is stored at step 414 and the priority is stored at step 416, the data valid field corresponding to the selected location is stored at step 418. Steps 414, 416, 418 show the logical steps in storing an item in a cache. More or fewer control steps may be required when the process is implemented in a semiconductor memory. For example, an item, priority and data valid bit may be stored simultaneously in one write operation. Conversely, if an item contains multiple words, step 414 may require multiple write operations. Further more, items may be retrieved from a fill buffer rather than from the cache while they are contained in the fill buffer. This may relax the ordering of steps 414, 416 and 418 within the cache during this interval. In this instance, the cache and fill buffer collectively achieve the same result as executing steps 414, 416 and 418 as shown.

When an empty way is available, the process of storing an item in the cache is similar to the prior art, except that a priority field is also stored for the item. However, when an empty way is not available, processing proceeds from step 410 to step 430. At step 430 a check is made to determine whether the location in any of the ways corresponding to the same Y address bits as the item to be stored has a priority lower than or equal to the item to be stored. If none of the corresponding locations in any of the ways has the same or lower priority, the storing process shown in FIG. 4 ends without the item being stored, effectively treating the item as not cacheable. Higher priority items are retained in the cache.

However, if a way with the same or lower priority is available, processing proceeds to step 432. At step 432 candidates for replacement are chosen. Preferably, all ways having the lowest priority provided to step 432 are selected as candidates for replacement. However, alternative implementations of the step are possible. One possible alternative is that all ways having the same or lower priority locations are selected as candidates for replacement.

At step 434 the replacement policy of the cache is applied to only the selected ways. As a result, when the new item is stored in cache 300, it overwrites an item previously stored in the cache only if the item being overwritten has the same or lower priority, or, depending on the selection process used at step 432, a lower priority. The specific replacement policy applied at step 434 is not critical to the invention. A least recently used or a least recently loaded replacement policy as in the prior art may be used.

Once the way to be replaced is selected, processing proceeds to step 414 where the new item is stored in the selected way. Thereafter processing proceeds to step 416 and 418 where the priority of the new item is stored and the data valid bit is retained in a set “true” state.

One benefit of the process shown in FIG. 4 is that processes that are of different priorities can run on the same processor chip and both use the same cache memory. Concern that a lower priority process will cause an overwrite of a location in the cache that stores information needed by a higher priority process is eliminated or, depending on the selection process used in step 432, reduced. As a result, there is less chance that a higher priority process will be delayed by needing to fetch information from off-chip memory that could have been stored in the cache.

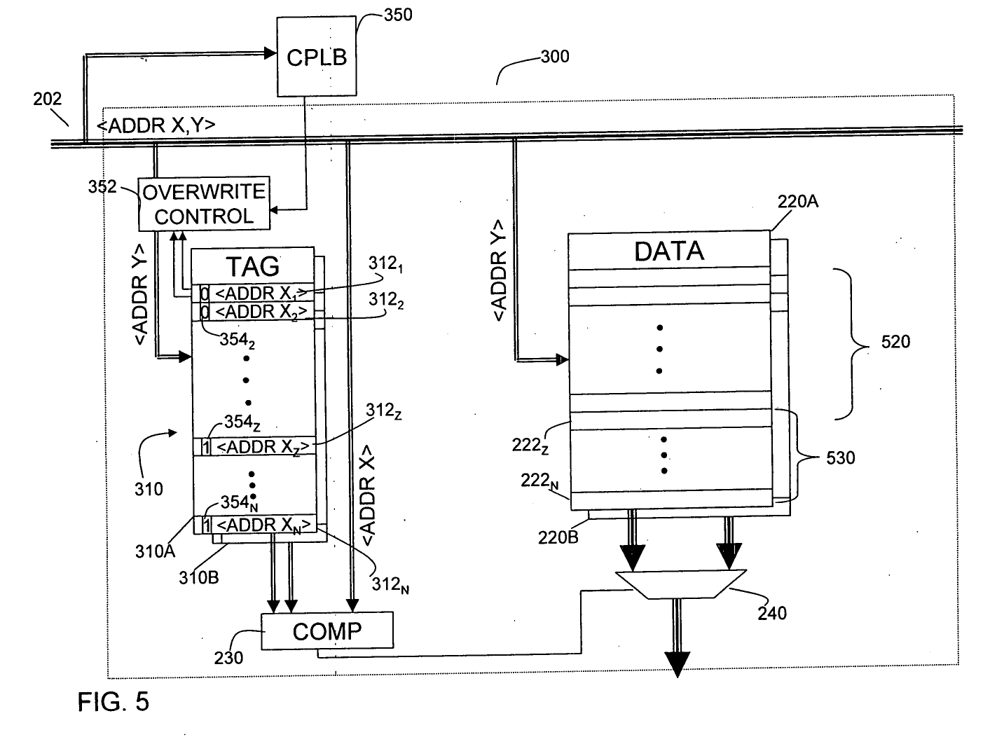

The architecture of cache 300 provides an added benefit of allowing dynamic reservation of memory locations in the cache memory. As shown in FIG. 5 a set of cache locations noted 312_{Z}-312_{N} have their priority bits set to one. All other priority bits are set to zero. Likewise, the priorities for all executing processes are set to zero in CPLB 350. Priorities for the process or processes using locations 312_{Z} . . . 312_{N} might not be set to zero. This arrangement of priority bits ensures that the memory locations in the data array corresponding to addresses 312_{Z} . . . 312_{N} are never used for caching information from off-chip memory. This use of the priority fields 354_{Z} . . . 354_{N} effectively creates two blocks of memory in the same way of the data array. Block 520 is used for normal cache operations. In contrast block 530 is not be used for the cache.

Block 530 is shown as a contiguous block of addresses for simplicity. Block 530 could be fragmented across multiple ways and addresses.

When a processor such as processor 100 is running a program, memory block 530 provides fast on-chip memory. For example, on-chip memory 530 might be used to store information for a process where time of execution is critical. However, the remainder of the way in data array is available for use as a cache. All portions of other ways may be reserved for fast memory access or may be allocated for use as a cache.

Because processor 100 uses a memory mapped architecture, each location in tag array 310 can be addressed separately. Separately addressing the locations in tag array 310 allows the priority bits of certain locations to be set to reserve a block 530 in one of the ways of the data array.

Having thus described several aspects of at least one embodiment of this invention, it is to be appreciated various alterations, modifications, and improvements will readily occur to those skilled in the art.

For example, the Y portion of the address for external memory locations is described as being used to address the tag array and the data array within a cache. It will be appreciated that this value need not be used as a direct, physical address. It is possible that the Y portion of the address is used as a logical address. The logical address may be converted to the actual physical address of the cache tag array and data array by adding an offset, scaling it or otherwise manipulating the logical address.

As another example, FIG. 4 shows that lower priority ways are first identified and then a replacement policy is applied. Alternatively, the replacement policy may be applied to select a specific way, but that way may be overwritten only if it contains an item of lower priority, or, depending on implementation, the same or lower proiority, than the new item to be stored.

Further, FIG. 4 shows that step 414 stores information in the data array and then fields in the tag array are updated at steps 416 and 418. The ordering of these steps is not a limitation on the invention.

Also, it was described that a process may replace only items in the cache with the same or lower priority. Similar results may be achieved if replacement of only items with lower priority is permitted.

Further, it is described that priority fields and the data valid fields are stored in the tag array. A convenient implementation of such structure is to have the priority and data valid fields in the same semiconductor memory as the tag array. It should be appreciated, through, that the fields can be physically located in any memory so long as the information they store can be accessed when needed. As a further example, it was described that the process of storing an item in a cache includes steps 410 and 412. Those steps verify whether empty cache locations exist before checking which location to use. Such steps might be omitted because they impact operation of the cache for only a small percentage of its operation. A program running on a data processor makes many accesses to memory and all locations in cache quickly get full. All locations could be treated as initially storing data. In this scenario, the locations in the cache will preferably be initialized with the lowest possible priority. The operation of the replacement policies might be adequate to ensure that unused locations get used before information in other locations is overwritten.

A further variation that is employed in the presently preferred embodiment is the ability to set the priority bits of all locations in the tag array with one write operation. In the presently preferred embodiment, a bit in a control register is mapped to all of the priority fields in the tag array. By writing to that one control bit, all priority fields change. Such a structure is useful, for example, in clearing the priority bit to release memory that was previously reserved or to clear the priority bits from the cache when a high priority process terminates. Upon termination of a high priority process, changing all priority bits in the cache to the lowest priority might be the only practical approach to ensure that cache locations accessed by that high priority process are returned to normal priority level for use by other processes.

In a further variation, the priority bits of all locations in the tag array that match a chosen level, or range of levels, may be converted to a new priority level—either higher or lower—with one write operation. This is useful, for example, in providing a system that is highly adaptive to changes of process priority, and providing a system that can easily consolidate process priorities as new processes are initiated when priority levels are scarce.

Such alterations, modifications, and improvements are intended to be part of this disclosure, and are intended to be within the spirit and scope of the invention. Accordingly, the foregoing description and drawings are by way of example only.

1. A method of operating a cache in a digital computer system, the cache having a plurality of memory locations, the method comprising:
a) obtaining a priority indicator with memory locations in the cache;
b) storing a new item in the cache by:
i) associating a priority with the new item;
ii) selecting a memory location in the cache based in part on the priority indicators of the memory locations in the cache relative to the priority of the new item;
iii) storing the new item in the selected memory location;
c) associating the priority of the new item with the selected memory location in the cache.

2. The method of operating a cache as in claim 1 wherein selecting a memory location in the cache based in part on the priority indicators comprises:
a) when the cache has an empty memory location suitable for storing the new item, storing the new item in an empty memory location;
b) when the cache has no empty memory location suitable for storing the new item, storing the new item in the least frequently used memory location with a priority indicator that is the same or lower than the new item, if one exists, otherwise not storing the new item in the cache and treating the new item as not cacheable.

3. The method of operating a cache as in claim 1 wherein selecting a memory location in the cache based in part on the priority indicators comprises storing the new item in the least frequently used memory location with a priority indicator that is the same or lower than the new item, if one exists.

4. The method of operating a cache as in claim 3 wherein selecting a memory location in the cache based in part on the priority indicators comprises:
a) when the cache has an empty memory location suitable for storing the new item, storing the new item in an empty memory location;
b) when the cache has no empty memory location suitable for storing the new item, storing the new item in the least frequently used memory location with a priority indicator that is lower than the new item.

5. The method of operating a cache as in claim 1 wherein selecting a memory location in cache based in part on the priority indicators comprises:
a) when the cache has an empty memory location suitable for storing the new item, storing the new item in an empty memory location;
b) when the cache has no empty memory location suitable for storing the new item, storing the new item in the least recently used memory location with a priority indicator that is the same or lower than the new item, if one exists, otherwise not storing the new item and treating the new item as not cacheable.

6. The method of operating a cache as in claim 1 wherein selecting a memory location in cache based in part on the priority indicators comprises: storing the new item in the least recently used memory location with a priority indicator that is the same or lower than the new item, if one exists.

7. The method of operating a cache as in claim 6 wherein selecting a memory location in cache based in part on the priority indicators comprises: storing the new item in the least recently used memory location with a priority indicator that is lower than the new item, if one exists.

8. The method of operating a cache as in claim 1 wherein selecting a memory location in cache based in part on the priority indicators comprises: storing the new item in the least recently loaded memory location with a priority indicator that is the same or lower than the new item, if one exists.

9. The method of operating a cache as in claim 8 wherein selecting a memory location in cache based in part on the priority indicators comprises: storing the new item in the least recently loaded memory location with a priority indicator that is lower than the new item, if one exists.

10. The method of operating a cache as in claim 1 wherein selecting a memory location in cache based in part on the priority indicators comprises: storing the new item in a psuedo randomly selected memory location with a priority indicator that is the same or lower than the new item, if one exists.

11. The method of operating a cache as in claim 10 wherein selecting a memory location in cache based in part on the priority indicators comprises: storing the new item in t a psuedo randomly selected memory location with a priority indicator that is lower than the new item, if one exists.

12. The method of operating a cache as in claim 1 wherein the cache contains a data array and a tag array and associating a priority indicator with a memory location comprises storing a value in a field in the tag array.

13. The method of operating a cache as in claim 1 wherein the digital computer system executes a plurality of processes, each process having a priority associated with it and the priority associated with the new item is derived from the priority of the process that generated the new item.

14. The method of operating a cache as in claim 1 additionally comprising:
a) assigning a first priority to a first portion of the plurality of memory locations;
b) assigning a second priority, lower than the first priority, to a second portion of the plurality of memory locations;
c) generating new items to store in the cache with priorities lower than or equal to the second priority; and
d) using the first portion of the plurality of memory locations for non-cache memory operations.

15. The method of operating a cache as in claim 14 wherein the digital computer system comprises a digital signal processor and using the first portion of the plurality of memory locations for non-cache operations comprises using the first plurality of operations for digital signal processing operations.

16. The method of claim 14 wherein assigning a first priority to a first portion of the plurality of memory locations comprises writing to a control register.

17. The method of claim 1 wherein associating a priority with a new item comprises reading a priority from a table associating priorities with memory addresses.

18. The method of claim 1 additionally comprising altering the priority associated with a plurality of memory locations in the cache by writing to a control register.

19. A processor system having a cache, the cache comprising:
a) a data array having a plurality of memory locations for storing items;
b) a tag array having a plurality of memory locations, each location associated with a location in the data array, each location in the tag array having associated therewith:
a first field, indicating a relative priority of the item stored in the associated location in the data array; and
a second field, indicating a portion of an address identifying the item stored in the associated location in the data array.

20. The processor system of claim 19 additionally comprising a memory management unit controlling storage of items in the cache coupled to the tag array whereby locations in the data array are assigned to new items according to a policy in which an empty locations is used, where available, and where no empty location is available, a location associated with a priority that is the same or less than a priority of the new item.

21. The processor system of claim 20 comprising at least one address bus with a plurality of address bits wherein the cache has an address input with a plurality of address bits coupled to at least a portion of the address bus, and the cache further comprises a plurality of ways, each of the ways having a location in the tag array addressed by a subset of the plurality of address bits, the cache further comprising selection circuitry that, upon application of an address to the address input, couples at least the first fields and second fields associated with the addressed location in each of the tag arrays in each of the ways to the memory management unit.

22. The processor system of claim 19 wherein each location in the tag array additionally 1 has associated therewith a third field indicating whether a valid item is stored in the associated location in the data array.

23. The processor system of claim 19 additionally comprising a control register having at least one control bit controlling the value stored in the first field of a plurality of memory locations in the tag array.

24. The processor system of claim 19 wherein the cache is implemented in SRAM.

25. The processor system of claim 19 additionally comprising:
a) a memory structure storing priorities associated with addresses; and
b) performance monitoring hardware monitoring a parameter indicative of cache efficiency and dynamically altering priorities stored in the memory structure.

26. A processor system, comprising:
a) a system bus;
b) a semiconductor chip comprising:
i) a processor core;
ii) at least one cache memory coupled to the processor core, the cache comprising a plurality of memory locations for storing items;
iii) a plurality of control bits associated with each memory location in the cache, the plurality of control bits associated with each memory location in the cache, with at least a first control bit for each memory location indicating whether valid information is stored in the memory location and at least a second control bit for each memory location indicating a priority of information stored in the memory location;
iv) a memory management unit coupled to the core, the memory management unit configured to receive as an input at least a first control bit and a second control bit, the memory unit having control outputs connected to the cache, the memory management unit having circuitry implementing a priority based cache replacement policy;
v) an interface to the bus; and
c) semiconductor memory outside the semiconductor chip coupled to the system bus.

27. The processor system of claim 26 wherein the processor core comprises circuitry to execute general purpose microprocessor instructing and digital signal processing functions.

28. The processor system of claim 26 wherein the cache memory is implemented as SRAM and the semiconductor memory is DRAM.

29. The processor system of claim 26 wherein the plurality of control bits additionally comprises a bit for each memory location indicating a replacement policy.

30. The processor system of claim 29 wherein the plurality of control bits additionally comprises a bit for each memory location indicating whether the information stored in the memory location differs from information stored in a corresponding location in the semiconductor memory.
